(19) United States
(12) Patent Application Publication
(10) Pub. No.: US 2012/0046952 A1
(43) Pub. Date: Feb. 23, 2012

(54) REMOTE CONTROL SYSTEM AND METHOD

(75) Inventors: EN-WEI HSU, Tu-Cheng (TW); CHIA-HUNG CHIEN, Tu-Cheng (TW)

(73) Assignee: HON HAI PRECISION INDUSTRY CO., LTD., Tu-Cheng (TW)

(21) Appl. No.: 13/113,741

(22) Filed: May 23, 2011

(30) Foreign Application Priority Data
Aug. 17, 2010 (CN) 201010255544.4

(51) Int. Cl. G10L 21/00

(52) U.S. Cl. 704/275; 704/E21.001

(57) ABSTRACT

A remote control system includes a receiving and recognition module, a converting module, and a control interface module. The receiving and recognition is used for receiving a signal from a user and recognizing the signal as a user command associated with an electronic device. The converting module is used for converting the user command into a control command identifiable by the electronic device. The control interface module is used for sending the control command to the electronic device to control the electronic device.

### BACKGROUND

1. Technical Field

The present disclosure relates to remote control systems and methods, and particularly to, a remote control system and method for controlling different electronic devices.

2. Description of Related Art

There are many different kinds of electronic devices. Each kind of electronic device has a control module and corresponding control commands. If users want to control a plurality of electronic devices, they may need to use different control modules. So, it is inconvenient for users to control at least two kinds of electronic device.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of the remote control system.

FIG. 2 is a flow chart of a remote control method of FIG. 1 in accordance with an embodiment.

FIG. 3 is a flow chart of an audio recognition process of FIG. 2 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

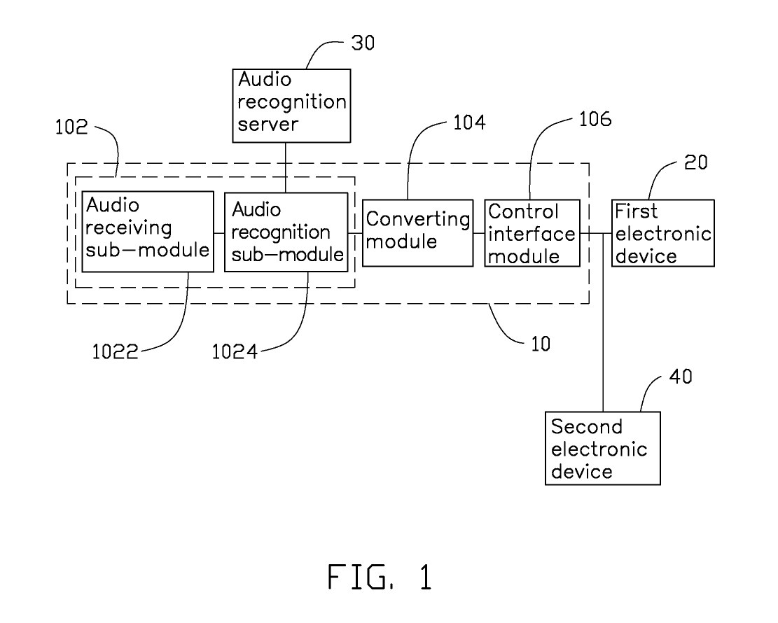

Referring to FIG. 1, a remote control system 10 is connected to a first electronic device 20 and a second electronic device 40. The remote control system 10 is configured to receive a user command and convert the user command into a control command to send to the corresponding electronic device. In one embodiment, the first and second electronic devices 20, 40 are any two of a computer, a digital photo frame, a digital television, a stereo system for example. The first and second electronic devices 20, 40 can communicate over a network via a known method such as with Wi-Fi, BLUETOOTH, infrared, 3G connection, and so on.

The remote control system 10 includes a receiving and analysis module 102, a converting module 104, and a control interface module 106. The receiving and analysis module 102 is connected to the converting module 104. The converting module 104 is connected to the control interface module 106. The receiving and analysis module 102 is connected to an audio recognition server 30. The control interface module 106 is connected to the first electronic device 20 and the second electronic device 40.

The receiving and analysis module 102 is used for receiving and analyzing a signal from a user. The signal may be an audio signal or a key command. The receiving and analysis module 102 includes an audio receiving sub-module 1022 and an audio recognition sub-module 1024. The audio receiving sub-module 1022 is used for receiving an audio signal from a user and sending the audio signal to the audio recognition sub-module 1024. In one embodiment, the audio receiving sub-module 1022 is a microphone. The audio recognition sub-module 1024 is used for recognizing voice commands and sending the voice commands to the converting module 104.

The audio recognition sub-module 1024 is connected to the audio recognition server 30. The audio recognition sub-module 1024 is used for sending the audio signal to the audio recognition server 30. The audio recognition server 30 is used for recognizing the audio signal, from the audio recognition sub-module 1024, as a user command corresponding to an electronic device and sending the user command to the audio recognition sub-module 1024. In one embodiment, the audio recognition server 30 is provided by a web-accessible multimodal interface (WAMI).

The converting module 104 is used for converting the user command into a control command identifiable by the corresponding electronic device and sending the control command to the control interface module 106. The control command includes a channel part and a content part. The channel part is the transmission method over the network, such as Wi-Fi. The content part is control information corresponding to the audio signal.

The control interface module 106 is used for sending the control command to the corresponding electronic device. For example, if the control command corresponds to the first electronic device 20, the first electronic device 20 performs actions corresponding to the control command.

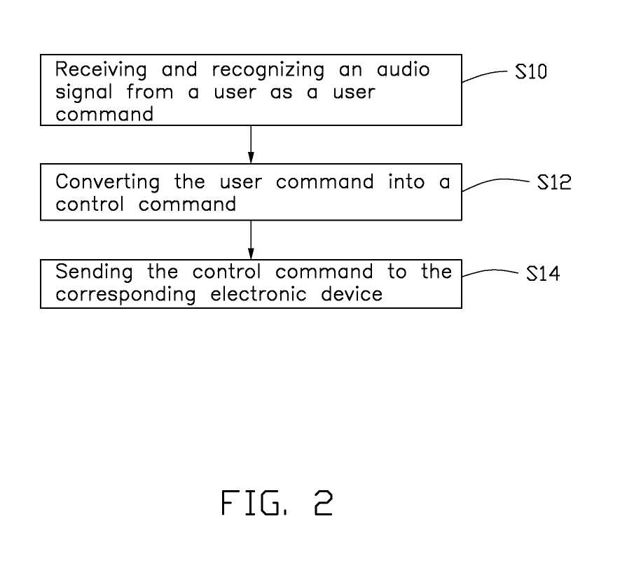

Referring to FIG. 2, a remote control method is shown. An embodiment of the method is as follows.

In step S10, the receiving and analysis module 102 receives a signal, such as audio signal, and recognizes the audio signal as a user command corresponding to an electronic device, such as the first electronic device 20.

In step S12, the converting module 104 converts the user command to a control command identifiable by the electronic device 20 and sends the control command to the control interface module 106.

In step S14, the control interface module 106 sends the control command to the electronic device 20 by network communication with the electronic device 20.

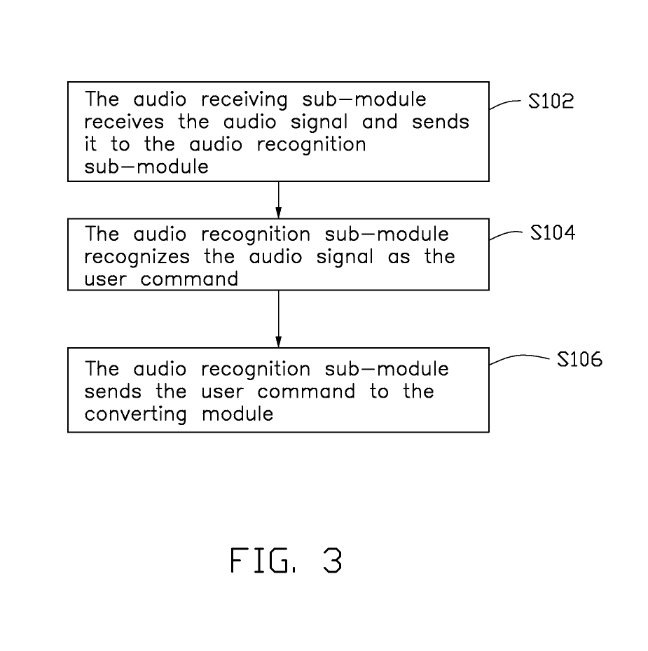

Referring to FIG. 3, an audio recognition process in step S10 is shown. An embodiment of the process is as follows.

In step S102, the audio receiving sub-module 1022 receives the audio signal and sends the audio signal to the audio recognition sub-module 1024.

In step S104, the audio recognition sub-module 1024 recognizes the audio signal as a user command.

In step S106, the audio recognition sub-module 1024 sends the user command to the converting module 104.

Wherein in step 104, the audio recognition sub-module 1024 sends the audio signal to the audio recognition server 30, and the audio recognition server 30 recognizes the audio signal as the user command and sends it to the audio recognition sub-module 1024.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A remote control system, comprising:
a receiving and recognition module, the receiving and recognition module adapted to receive a signal and recognize the signal as a user command associated with an electronic device;
a converting module, the converting module adapted to convert the user command into a control command that is identifiable by the electronic device; and
a control interface module, the control interface module adapted to send the control command to the electronic device.

2. The remote control system of claim 1, wherein the signal is an audio signal and the receiving and recognition module comprises an audio receiving sub-module and an audio recognition sub-module; the audio receiving sub-module is adapted to receive the audio signal, and the audio recognition sub-module is adapted to recognize the audio signal as the user command by analyzing the audio signal.

3. The remote control system of claim 2, further comprising an audio recognition server, wherein the audio recognition sub-module is connected to the audio recognition server, and the audio recognition sub-module recognizes the audio signal by the audio recognition server.

4. The remote control system of claim 3, wherein the audio recognition server is provided by a web-accessible multimodal interface.

5. A remote control method, comprising:
receiving a signal;
recognizing the signal as a user command associated with an electronic device;
converting the user command into a control command identifiable by the electronic device; and
sending the control command to the electronic device to control the electronic device.

6. The remote control method of claim 5, wherein the signal is an audio signal.

7. The remote control method of claim 6, wherein the recognizing the signal as the user command comprises:
sending the audio signal from an audio recognition sub-module to an audio recognition server; and
recognizing the audio signal as the user command by the audio recognition server.

8. The remote control method of claim 7, wherein the audio recognition server is provided by a web-accessible multimodal interface.

9. A remote control method, comprising:
providing an remote control system, the remote control system comprising a receiving and recognition module, a converting module, and a control interface module;
the receiving and recognition module receiving a signal from a user and recognizing the signal as a user command;
the converting module converting the user command into a control command identifiable by an electronic device; and
the control interface module sending the control command to the electronic device to control the electronic device.
